(19) United States
(12) Patent Application Publication
(10) Pub. No.: US 2020/0396280 A1
(43) Pub. Date: Dec. 17, 2020

(54) Resource Management Metrics For An Event Loop

(71) Applicant: NodeSource, Inc., San Francisco, CA (US)

(72) Inventor: Trevor Norris, Salt Lake City, UT (US)

(21) Appl. No.: 16/440,401

(22) Filed: Jun. 13, 2019

(51) Int. Cl. H04L 29/08; H04L 12/26

(52) U.S. Cl. CPC H04L 67/1008; H04L 67/101; H04L 43/0852

(57) ABSTRACT

Systems, methods, and devices for determining event loop responsiveness of a server. A method includes calculating provider delay for an event loop indicating a duration of time events waited. The provider delay is based on loop processing time indicating an aggregate time duration the events waited before being received by an event provider of the event loop, and a quantity of the events that waited to be received by the event provider. The method includes calculating processing delay for the event loop indicating a duration of time to fully process the events. The processing delay based on the loop processing time and a quantity of the events provided by the event provider to an event handler.

### TECHNICAL FIELD

The present disclosure relates to computing resources metrics and particularly relates to metrics pertaining to an event loop.

### BACKGROUND

Computers may run a wide range of applications that can be configured for performing different functions, tasks, or activities for the benefit of a user. Applications can be run on personal computing devices such as laptops, smart phones, and tablets. Applications can also be run on other computing resources such as servers or virtual warehouses that may be in communication with a network and provide a web-based application. All applications require a certain amount of processing capacity to run effectively. If an application is not provided adequate processing capacity, the application may run slowly or may timeout and fail. If an application is provided more processing capacity than it needs, computing resources may go unused so that a computer or server is not used optimally. The processing capacity of a computing resource is measured by the number of operations the computing resource's processor can perform in a set amount of time.

Computers have a central processing unit (“CPU”) that may also be referred to as a central processor or main processor. The CPU is the electronic circuitry within the computer that carries out instructions in a computer program. The program or application may instruct the CPU to perform arithmetic, logic, controlling operations, input/output (I/O) operations, and so forth. The form, design, and implementation of CPUS has changed over time, but the fundamental operation of a CPU remains mostly unchanged. CPUs, regardless of their physical form, are configured to execute a sequence of stored instructions. The instructions include programming logic and may be referred to as a program or application. The instructions to be executed may be stored in some form of memory and the CPU may be configured to retrieve, decode, and execute the steps in the instructions. This process of retrieving, decoding, and executing may be referred to as the instruction cycle. After the execution of an instruction, the instruction cycle repeats so that the next instruction cycle retrieves the next-in-line instruction.

The retrieving step of the instruction cycle includes retrieving an instruction which is represented by a number or sequence of numbers. The instruction may be retrieved from memory or may be received over a network. The decode step of the instruction cycle includes converting the number or sequence of numbers in the instruction into signals that control other parts of the CPU. The instruction may be decoded differently based on the instruction set architecture of the CPU. The execution step of the instruction cycle includes executing a single task or a sequence of tasks. During each task, different parts of the CPU may be electrically connected so they can perform all or part of the desired operation. When the tasks are completed, the results of the operation may be written to an internal CPU register for quick access by subsequent instructions or may be written to slower memory having a higher capacity.

In computer science, there exists a programming construct called an event loop. The event loop may alternatively be referred to as a message dispatcher, a message loop, a message pump, or a run loop. The event loop waits for and dispatches events or messages in a program. The event loop works by making a request to some internal or external event provider which in turn calls an event handler to dispatch the event. The event loop may form the central control flow construct of a program. The event loop is a different approach compared with menu-driven designs or running the program one time and then terminating the program. In menu-driven designs, a user may be presented with a narrowing set of options until the task the user wishes to carry out is the only option available. In a traditional approach, the program is run one time and then terminates. This traditional approach was common in the early days of computing and lacked user interactivity.

The event loop may be implemented for applications and programs that have high-volume workloads, various transaction sizes, and other input/output-intensive operations. The event loop may particularly be used in web-based applications that may be accessed by way of a web browser or other applications. The event loop may be in communication with a user by way of an application programming interface (API). The API is a software intermediary that allows two components to communicate with each other. The API may serve as a communication channel to deliver and receive a user request to an external application. In the context of web-based applications, each tab in a browser may utilize an event loop API to handle calls, and the API may serve as a communication channel to indicate what a user (e.g. a person interacting with a web browser) wishes to do.

Applications and processes with sustained high-volume workloads, various transaction sizes, and other input/output-intensive environments are prevalent across numerous industries. An example of such an application is a content delivery network (CDN). A CDN is used to deliver web pages and other web content to the user and is specifically used in scenarios where high-volume traffic is expected. High-performance environments may involve varying requirements for data storage but may have active workloads with many transactions of various sizes or a smaller number of transactions requiring high bandwidth. When there are many transactions or when each transaction requires many processing resources to complete, the program requires a significant amount of computing resources. In some instances, it is desirable to know how much computing power is required to execute a program. This knowledge enables the amount of computing power to be specifically tailored to a program so the program never fails or times out for lack of computing power, and further so that computing power does not go unused or “wasted.” Such high-performance environments may be optimized by scaling processing resources up or down based on specialized metrics for the event loop.

Systems using an event-driven programming construct can be utilized in high-volume workloads with one or more clients. Certain event-driven systems include an event loop where the caller is decoupled from the response such that processing resources may be utilized efficiently for asynchronous operations. In the event loop, a request is made to an event provider, and when an event arrives it is passed to a user supplied callback via an event handler for processing. The event loop is a resource allocation mechanism that includes loop idle time and loop processing time. The systems, methods, and devices disclosed herein provide an improved approach to capturing metrics pertaining to an event loop so that processing resources may be scaled effectively.

### BRIEF DESCRIPTION OF THE DRAWINGS

Non-limiting and non-exhaustive implementations of the present disclosure are described with reference to the following figures, wherein like reference numerals refer to like or similar parts throughout the various views unless otherwise specified. Advantages of the present disclosure will become better understood regarding the following description and accompanying drawings where:

FIG. 1 is a schematic block diagram of a system for processing events through an event loop, according to one embodiment of the disclosure;

FIG. 2 is a schematic block diagram of an event loop process flow for calculating event loop responsiveness, according to one embodiment of the disclosure;

FIG. 3 is a schematic block diagram of an example event loop, according to one embodiment of the disclosure;

FIG. 4 is a schematic block diagram of an event loop, according to one embodiment of the disclosure;

FIG. 5 is a block diagram of an event travelling through an event loop, according to one embodiment of the disclosure;

FIG. 6 is a schematic flow chart diagram of a method for calculating event loop responsiveness for an event loop, according to one embodiment of the disclosure;

FIG. 7 is a block diagram depicting an example computing device or system consistent with one or more embodiments disclosed herein;

FIGS. 8A-8C are graphs depicting an example workload that makes two sequential requests to a remote service for data necessary to complete the request, according to one embodiment of the disclosure;

FIGS. 9A-9C are graphs depicting an example workload that spends time processing a user's request before making a single request to a remote service that can respond quickly, according to one embodiment of the disclosure;

FIGS. 10A-10C are graphs depicting an example workload that first makes a request to an external service and offloads cryptographic work to a different thread, according to one embodiment of the disclosure; and

FIGS. 11A-11C are graphs depicting an example workload that has each client making several pipelined requests that require two sequential requests to an external service, according to one embodiment of the disclosure.

### DETAILED DESCRIPTION

The systems, methods, and devices disclosed herein provide improved means for capturing and calculating metrics regarding the use of computing resources. Such metrics can be used to scale processing capacity up or down for a specific program so that a program does not time out or fail for lack of processing capacity, and further so that significant volumes of processing capacity do not go unused or wasted. One such metric disclosed herein pertains to event loop responsiveness. The event loop responsiveness metric is a new metric that enables significant improvements for measuring how long it takes to receive and process an event loop cycle.

The event loop responsiveness metric is calculated by approximating what tasks the application is performing by capturing metrics indirectly during runtime of an event loop. The indirect capture and measurement of event loop responsiveness enables significant benefits for an application that is running a program with an event loop. Traditionally, it is necessary to collect metrics by directly monitoring the program's instructions that are responsible for execution of the task responsible for utilizing computational resources. This means that the capture and measurement of those metrics adds overhead to the program and can interfere with debugging utilities in the program. Collecting metrics often involves interfering with the program to observe what instructions are being executed. This observation and inference require computational resources that could otherwise be dedicated to the program, incurring overhead that can slow down the execution speed of the program. In addition, and especially applicable to scripted languages like JavaScript, the additional metrics collection can affect the call stack, possibly making it more difficult to debug the application.

Event loop responsiveness is indirectly related to response latency, which is a time interval between when a request is received, and a response is sent back to the client. The event loop responsiveness is a calculation based on metrics collected from event loop operations, instead of using direct observations of the code's execution. These event loop operational metrics are used to calculate a close approximation of the actual response latency.

The measurement of “event loop responsiveness” as disclosed herein provides improved means to determine whether processing capacity is being optimized. In some instances, it is desirable to ensure that the processing resources can handle an average workload but can also handle peak workload levels without degrading the performance of a program for any users. In some implementations, a program is available to many different users. The program may be available by way of a web-based interface such as a web page or other networked program. The program may be used by varying numbers of users at different times. The program may undergo low periods when few users are using the program and the amount of required processing capacity is low. The program may undergo average periods, for example during operating hours, when the number of users accessing the program is largely sustained over time and is mostly predictable. In some instances, the amount of available processing capacity may be largely determined based on the average periods of use for the program. The program may undergo peak periods when the number of users accessing the program is very high. Peak periods may occur each day at a certain time, they may occur on certain days in response to some event, and/or they may be unpredictable. The event loop responsiveness metric provides an improved means to determine whether the amount of processing capacity that is provided to a program is adequate to service average periods and peak periods for the program while keeping response latency below a chosen threshold.

The event loop responsiveness metric may be used to trigger auto-scaling events to scale the processing resources that are provided to a program. The processing resources may be added or removed to meet demand. When the scaling is based on the event loop responsiveness metric as described herein, the scaling may be accomplished with improved fidelity when compared with other known metrics such as central processing unit (CPU) usage. The event loop responsiveness metric may further be used to inform load balancing mechanisms to distribute work across a cluster of processing resources. The work may be distributed according to the ability of each processing resource to handle additional work.

The resource utilization of computers and networked computing infrastructure may be improved by monitoring the infrastructure of an application by collecting application runtime data regarding individual software components that are invoked in the application. In an event-driven programming construct involving an event loop, an event loop capacity metric may be determined which indicates an approximation of proportional use of available resources. The event loop capacity metric may be used to trigger auto-scaling events to scale application cluster resources both up and down to meet demand. When used in conjunction with CPU usage, the event loop capacity metric may indicate whether an application has reached its resource limit due to application code limitations or due to the amount of resources allocated to the process.

Systems, methods, and devices are disclosed for monitoring runtime data and generating event loop metrics for enhancing capacity planning and efficiency. In certain applications of the disclosure, an event loop is a key resource allocation mechanism for measuring an ability to process events. Specifically, the disclosures herein may be applied to a Node.js event loop. It should be appreciated that the disclosures presented herein may be implemented on any suitable system, and particularly on any suitable event loop system, and need not be implemented in Node.js. For many typical Node.js applications, a majority of execution time is spent waiting for network, file systems, and database transactions to complete. Node.js may handle high request volumes due to asynchronous input/output methods that allow simultaneous requests to be served during the time it takes for a read/write to complete.

Under continuous high workload, it can be critical to know the performance and health of applications to ensure proper scaling of computing resources and distribution of load. Many high input/output cases develop scalability issues, so ensuring visibility in performance metrics may be critical to detecting and resolving issues before those issues cause a major system failure or denial of service. In certain implementations, the solution to scaling gracefully may be to create more instances of an application, distribution across multiple processes and/or computing devices, or other changes to architecture. However, without insight into the behavior of an application, it is challenging to identify and implement the best case-specific solution. The methods, systems, and devices disclosed herein provide enhanced visibility into application behavior and overall system health with performance metrics captured at runtime. The performance metrics disclosed herein provide improved views of how code behaves in a production environment, load test, batch process, staging, and other environments.

The event loop responsiveness metric may be consumed per event loop, aggregated across multiple event loops within a single process or program, and/or aggregated over part or all an application cluster that includes one or more processes being executed on one or more computing devices. At the event loop level, the event loop responsiveness metric may indicate the event loop responsiveness in relation to a current input/output load being experienced by the computing resources allocated to that event loop. As an aggregate metric, the event loop responsiveness may indicate an overall process where a process includes multiple event loops. Further, an aggregated event loop responsiveness metric may provide high level indicators of the health of an application. The event loop responsiveness metric may serve as a frontline indicator for triggering, for example, scaling of computing resources, allocation of application processes to new incoming input/output load according to current event loop responsiveness, or tuning application code to better manage current load with available computing resources.

The event loop responsiveness metric can be applied to numerous uses, including application as metrics for triggering auto-scaling events. In an example, the event loop responsiveness indicates that an application cluster should scale up or down to meet demand. The event loop capacity metric may provide scaling with greater fidelity than CPU usage, which is classically used to trigger such scaling events. Further, when used in conjunction with CPU usage, the responsiveness metric can indicate whether the processing resources can keep up with demand and meet all event loop requests. For example, when running a process within a container that has been allocated a single CPU, performing work off the main event loop thread will cause the process to reach its CPU resource limit before the event loop begins to reach its maximum capacity to process additional events. Additionally, event loop responsiveness may provide a useful indication of overall event loop health that may be more valuable than other lower level metrics at surfacing first-level concerns about overall performance of an application and/or an individual process.

In an embodiment, computing resources may be scaled up or down based on the event loop responsiveness metric. In an embodiment, by scaling an application cluster using the event loop responsiveness metric rather than a generic metric such as CPU usage, the responsiveness of the application may be improved by ensuring that enough resources are always available to handle additional event processing (e.g. incoming network traffic), and/or save cost be ensuring that resources do not remain idle. Various metrics understood in the art have failure modes or weaknesses that the event loop responsiveness metric does not suffer from. For example, a process performing a series of cryptographic operations may perform work off a main event loop thread, and in this case, process CPU usage may go well above the scaling limit even where the main event loop thread is not near the limit of how many events can be processed.

In an embodiment, an auto-scaling trigger range may normally be informed by the needs of a user and the user's expectation of constancy in traffic. For example, an application expecting to receive traffic with bursts of activity may need to over-provision processing resources to be optimally reactive to changes in load. Further for example, an application expecting a relatively constant load with slower variations may set a tighter range to experience cost benefits of provisioning closer to the actual ability to handle the load. Event loop responsiveness may be used to drive decisions with greater precision regarding the tradeoff between responsiveness and the cost of maintaining a cluster of processes. For example, where the priority is to minimize the 99^{th} percentile response latency for all users for a more consistent user experience, capacity overhead may be built into the acceptable event loop responsiveness value range that triggers scaling events. For example, in a more cost-sensitive situation where occasional higher-latency responses are acceptable, a cluster may be scaled within a tighter relation to overall capacity such that the correct amount of processing resources (e.g. hardware, containers, or other cost unit) is utilized without unnecessary excess.

As used herein, “event loop” may refer to a programming construct that pauses execution when waiting for arrival or retrieval of an event for processing. The event loop may alternatively be referred to as a message dispatcher, a message loop, a message pump, a run loop, a main loop, or a main event loop. The event loop makes a request to an internal or external event provider and then calls the relevant event handler that is configured to dispatch the event. The event loop is in contrast with a traditional command-line-driven alternative where a program is run one time and then terminated. The event loop is further in contrast with a menu-driven design that may still feature a main loop but presents an ever-narrowing set of options until the appropriate task is the only option available.

As used herein, an “event” may refer to an entity that encapsulates an asynchronous action and a contextual variable trigger of the action when received by the event loop. The event may include programming logic that provides instructions to a processor indicating one or more actions for the processor to execute. The event may include application information for an underlying development framework that may be associated with a graphical user interface (GUI) toolkit or some form of input routine. The event may include, for example, an indication of a key stroke, mouse activity, action selections, timer expirations, and so forth. Further, the event may include, for example, opening or closing files, opening or closing data streams, reading data, writing data, and so forth.

As used herein, “event provider” may refer to a mechanism for pausing execution of the event loop to wait for arrival of an event. The event provider may be passed a timeout at a time of an event provider request and the timeout may last a maximum duration of time the event provider waits before returning. The event provider may refer to the component of the event loop responsible for pausing execution of the event loop and waiting for arrival of the event from asynchronous event generation mechanisms, such as incoming network requests, filesystem data reads, CPU interrupts and other such mechanisms. The event provider may implement a utility such as “poll”, “kqueue”, “select” or message passing mechanisms as provided by dependent utilities or operating systems.

As used herein, “event queue” may refer to a construct that holds a reference to an event upon completion of an action or task and prior to being received by an event provider. Events may be placed in the event queue before being received or retrieved by the event provider. In some, but not necessarily all embodiments, an event queue can receive items at the “back” of the line of events waiting to be retrieved, and events waiting to be retrieved can be retrieved from the “front” of the line. Further in some, but not necessarily all embodiments, the event queue can store a listing indicating when and/or in which order events were received by the event queue.

As used herein, an “event handler” may refer to a callback routine that may operate asynchronously to handle events received from an event loop. The event handler includes capabilities to process events. The event handler may be configured to execute instructions associated with any suitable event, such as keystrokes, mouse movements, action selections, opening or closing a file, opening or closing a data stream, reading data, writing data, providing content web content, and so forth.

In an embodiment, the event loop responsiveness metric is determined based on an event processing delay. The processing delay is a duration of time events waited from being received by the event provider to being processed. The duration of time begins when an event is received/retrieved by the event provider and concludes when processing of the event begins. The event processing delay is aggregated and averaged over a time period for all events that were processed by the event loop during the time period. The event processing delay may be referred to herein with the variable, “R.”

To facilitate understanding of the event loop and the metrics that are described herein, the event loop may be analogized to an inbox and outbox of tasks to be completed. In the analogy, the event loop includes receiving tasks in the inbox, reviewing the tasks in the inbox, distributing the tasks to appropriate workers, and completing the tasks. A single task that is received by an inbox can be analogized to an event in the event loop. The inbox itself can be analogized to the event queue. In the analogy, the tasks in the inbox can be received by a secretary, and the secretary can be analogized to the event provider. The secretary (the event provider) receives a batch of tasks from the inbox and provides the batch of tasks to a worker to complete the tasks. In the analogy, the worker can be analogized to the event handler. When the secretary provides the batch of tasks to the worker, this step can be analogized to an event being retrieved by the event provider and provided to an event handler. The worker opens each individual task in the batch of tasks one-by-one, and this step can be analogized to the event handler reading the programming logic or code in each event in a batch of events. The worker handles each task one-by-one, and this step can be analogized to the event handler processing or executing each event. In some implementations, there may be multiple workers (multiple event handlers) that can each open and perform tasks in parallel. This can be analogized to the event loop having multiple event handlers that can read and execute events in parallel. It should be appreciated that the above analogy is non-limiting to the disclosure and is provided only for facilitating understanding of the event loop.

In an embodiment, the provider delay P is determined according to Equation 1, below.

$${P}_{n} = \frac{{d}_{n} {a}_{n - 1}}{2} \qquad Equation 1$$

where d is a quantity of the events waiting in the event queue when the provider request is made, a is the loop processing time and n is an identifier for the loop iteration. The loop processing time (variable a) is an aggregate time duration taken to process all events in a single iteration of the event loop.

In an embodiment, the processing delay S is determined according to Equation 2, below.

$${S}_{n} = \frac{{a}_{n} ( {k}_{n} - 1 )}{2} \qquad Equation 2$$

where a is the loop processing time, k is the loop events processed, or the quantity of events dispatched to the event handler in an iteration of the event loop, and n is an identifier for the loop iteration. The loop processing time (variable a) is an aggregate time duration the events took to be processed by the event handler.

In an embodiment, the event loop responsiveness metric R is determined according to Equation 3, below.

$${R}_{n} = \frac{{P}_{n} + {S}_{n}}{{a}_{n}} \qquad Equation 3$$

where upon expansion and simplification the event loop responsiveness metric is determined according to Equation 4, below.

$${R}_{n} = \frac{{a}_{n} {k}_{n} - {a}_{n} + {d}_{n} {a}_{n - 1}}{2 {a}_{n}} \qquad Equation 4$$

Further to the above analogy to illustrate the accumulation of the duration of time, a first task is dropped off at the inbox at 11:00 am, a second task is dropped off at 12:00 pm, a third task is dropped off at 1:00 pm, and all three tasks are retrieved from the inbox at 2:00 pm. The accumulation of time for the three tasks is six hours because the first task waited in the inbox for three hours, the second task waited in the inbox for two hours, and the third task waited in the inbox for one hour, and the wait time for each of the three tasks is summed to reach the accumulation of time.

In an embodiment, loop processing time does not include work done off an event loop thread such as for computationally expensive cryptographic work performed asynchronously in Node.js. The loop processing time is an aggregate duration of time taken to process all events in an iteration of the event loop. The provider delay is an aggregate time duration events waited in the event queue until being received by the event provider. The processing delay is an aggregate time duration events waited after being received by the event provider until being processed by the event handler. In an embodiment, the loop idle time is the length of time the event provider spends idly waiting for arrival of an event. In an embodiment, the loop idle time refers only to the time spent idling in the event provider request when there are no available events to process. In an embodiment where there are one or more events waiting, or events waiting in the event queue upon the event provider request, the time spent in the event provider is utilized to retrieve the list of available events and the event loop is not actually idle. Further, time spent retrieving the event queue may not be included in the loop idle time regardless of whether the event provider idled. In an embodiment where the number of events retrieved after the event provider has idled is typically close to one, the amount of time spent waiting may be short enough that it does not have a noticeable impact on aggregated metrics.

The event loop responsiveness metric is calculated on each loop iteration. For the event loop responsiveness metric to be consumable by the user it must be stored in an alternative form. To achieve this the event loop responsiveness metric is placed in the exponential moving average M is determined according to Equation 5, below.

Mₙ=Mₙ₋₁+α(Rₙ−Mₙ₋₁) Equation 5

The exponential moving average is expected to behave similar to time-series data. The time interval between loop iterations is not consistent. Therefore, the time constant α (alpha) is used to adjust for the irregularity and is determined according to Equation 6, below.

$$α = 1 - {e}^{\frac{- Δ T}{τ}} \qquad Equation 6$$

where e is Euler's constant, [symbol] T is the difference in time from the last entry into the exponential moving average and τ (tau) is period of time to smooth over.

The difference in time from last entry [symbol] T is the same as the loop duration. Expanding α below the exponential moving average at loop iteration n is determined according to Equation 7, below, where c is the loop duration.

$${M}_{n} = {M}_{n - 1} + ( 1 + {e}^{\frac{{α}_{n}}{τ}} ) ( {R}_{n} - {M}_{n - 1} ) \qquad Equation 7$$

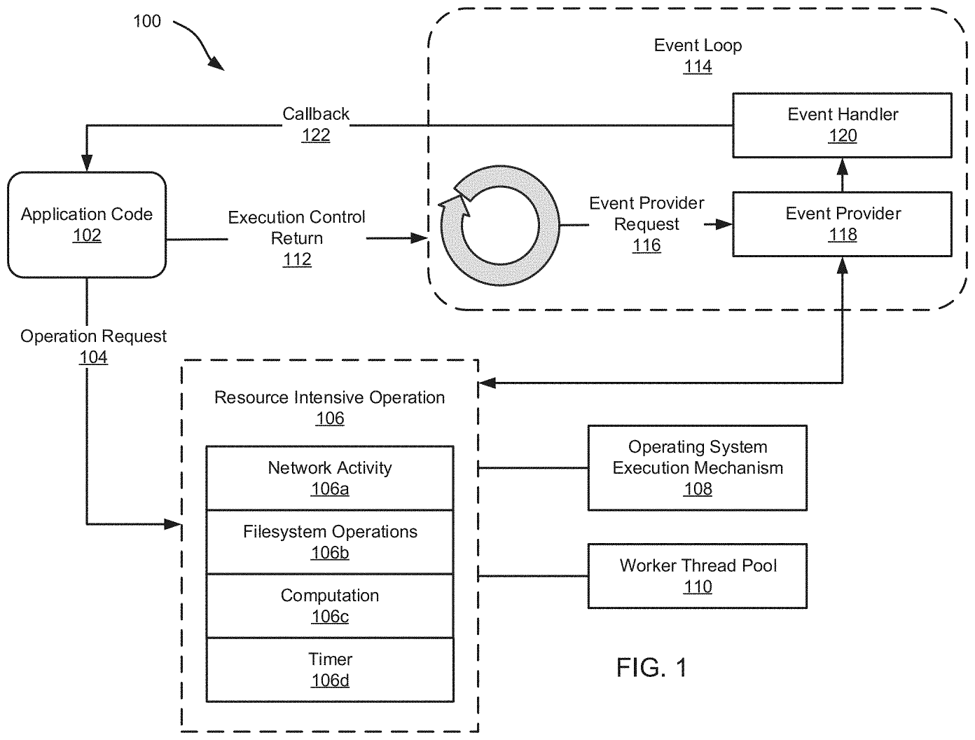

Referring now to the figures, FIG. 1 illustrates a block diagram of a system 100 for processing requests through an event loop. The system 100 may be implemented in various implementations and environments, including for example Node.js. In the system 100, application code 102 may cause an operation request 104 for a resource intensive operation 106 to be executed in an asynchronous manner. Example operations of the resource intensive operation 106 may include, for example, network activity 106a, filesystem operations 106b, computation 106c such as CPU-intensive computation, or timers 106d. Such resource intensive operations 106 may be executed by means of an operating system execution mechanism 108 (such as asynchronous network requests), worker thread pool 110, or other means of asynchronous execution. Once the application code 102 has finished its current block of synchronous execution, it returns application execution control 112 to the event loop 114. The event loop 114 periodically executes an event provider request 116 to an event provider 118 to receive the status of ongoing operations. The event provider 118 implements an event receiver operation appropriate for the system and/or operation types being executed (e.g. “poll”, “select”, “kqueue”, etc.) and can retrieve events or alternatively wait for a specified timeout period, blocking the event loop 114 while waiting for additional events. Once available, one or more events are returned to the event loop 114 to an event handler 120 which is responsible for event filtering, adjustment and/or passing events to application code via a user-supplied callback 122 within the application code 102. The callback 122 may include promises, continuations, futures, and so forth. Execution control is passed to the application code 102 by means of such a callback 122, where control remains and may trigger additional operation requests 104 before returning execution control 112 back to the event loop 114 for additional cycles of this process.

In an embodiment, a plurality of process threads is utilized. The event loop 114 executes within one such thread, which may alternatively be referred to as the main loop, main event loop, main thread, or event thread. The event loop 114 causes application code 102 to execute within the same thread (which may in turn utilize additional threads for its own purposes). Some operations are executed via a non-blocking or asynchronous mechanisms via the operating system execution mechanism 108 which are outside the control of the event loop 114. Other operations execute within a worker thread pool 110 which contains one or more of another type of thread and may alternatively be referred to as the thread pool or worker pool. While a thread is executing an operation (e.g. the main thread executing application code, or a worker thread executing an intensive task), the thread is said to be blocked. While a thread is blocked, it is not able to handle work created by additional operation requests 104. While the main thread is blocked, the event loop 114 is unable to receive and handle additional requests. This provides motivations (e.g. performance and security) for minimizing thread blocking in both the main thread and the worker thread pool.

Certain intensive operations are executed via means of a worker thread pool 110, while others are delegated to the operating system (e.g. Linux™, OSX™, Solaris™, or Windows™) via an operating system execution mechanism. Such a mechanism is typically (but not exclusively) exposed in the form of file descriptors that are used to interact with input/output components of a system. The event provider 118 uses an operating system specific mechanism, such as “poll” to inspect these file descriptors whereby the operating system is asked for the status of certain file descriptors. Activity in a file descriptor, e.g. network activity being triggered by an external client, causes the operating system to create an event which is passed via the event provider 118 through to the event loop 114 to the event handler 120 and may additionally be passed out of the event loop 114 to application code 102 via a callback 122. Operations executed within the worker thread pool 110 may also be encapsulated in events that are similar to operating system events. All events are provided to the event loop 114 for handling. Such handling generally involves eventually triggering a callback 122 into the application code 102 where the event is passed for handling according to the application logic.

In an embodiment, the event loop 114 maintains a first-in-first-out (FIFO) event queue such that every new event is placed at the back of a line and waits its turn to be handled by the event handler 120 (and potentially application code 102 via a callback 122). The event loop 114 may alternatively be referred to as a message dispatcher, message loop, message pump, and/or run loop. The event loop 114 may form the central control flow construct of a program and may constitute the highest level of control within the program. The event loop 114 may be utilized as a method for implementing inter-process communication and may be a specific implementation technique for message passing.

The event includes an action or occurrence recognized by software and it may originate asynchronously from an external environment. Events may be generated and/or triggered by a thread other than the main thread via the worker thread pool 110 or the operating system execution mechanism 108 or may originate from an external input/output device, an internal input/output device, a system timer, a system interrupt, a user, a network operation and so forth. Events may be handled synchronously with program flow such that software may have one or more dedicated places where events are handled. Such places are triggered in application code 102 via callbacks 122 but may extend to many other places within an application according to the programmed logic. A source of the event may include a user interacting with software by way of, for example, keystrokes on a keyboard. A source of the event may be a hardware device such as a network interface. A source of the event may be an internal system construct such as a timer interrupt. Additionally, software may trigger one or more events into the event loop 114, e.g. to communicate the completion of a task, and so forth.

Events may be eventually handled in application code by callbacks 122. Each event may be a piece of application-level information from an underlying framework such as a graphical user interface (GUI) toolkit. Such GUI events may include, for example, key presses, mouse movement, action selections, timers expiring, and so forth. Additionally, an event may represent availability of new data for reading a file or network stream.

An event provider 118, which may make use of a poll-type operation in some circumstances. Such a poll operation is a means by which the event loop may request events from a system. Such poll operations may be used to block the main thread until an event is available, or until a predetermined timeout occurs. In an embodiment, the event provider 118, is given a timeout equal to a maximum duration of time to wait before returning, regardless of whether an event is available or not. The event provider 118 may return zero to many events in response to a single event provider request 116. The use of a timeout is a means by which an event loop 114 does not expend unnecessary time querying for events where none exist, thereby expending unnecessary resources. An event-driven application (primarily embodied in the application code 102), making use of an event loop 114 application does not require execution unless events exist to be processed. Where no events exist to be processed, a timeout is an appropriate mechanism to pause (or block) a thread.

A loop duration is a duration of time occupied by the event provider 118, (i.e. a duration of time an event provider 118 runs as a result of an event provider request 116) and the event handler 120, which may include execution of application code 102 invoked by the event handler 120 via callbacks 122. A wait time (may also be referred to as an event loop poll time or a poll time) is a duration of time occupied by the event provider 118 (i.e., a duration of time an event provider 118 runs required as a result of an event provider request 118).

In a Unix implementation, the “everything is a file” paradigm may lead to a file-based (or file-descriptor based) event loop 114. Reading from (often “polling”) and writing to files, inter-process communication, network communication, and device control may be achieved using file input/output with the target identified by a file descriptor via a “select” operation. The select and poll system may allow a set of file descriptors to be monitored for a change of state, e.g. when data becomes available to read.

In a Microsoft Windows™ implementation, a process that interacts with a user must accept and react to incoming messages, and this may be performed by a message loop in that process. The message may be equated to an event created and imposed upon the operating system. The event may include, for example, user interaction, network traffic, system processing, timer activity, inter-process communication, and so forth. Further, for non-interactive, input/output only events, the Microsoft Windows™ implementation may have input/output completion ports. The input/output completion port loops may run separately from a message loop and do not interact with the message loop out of the box.

Both Unix and Microsoft Windows™ implementations may be abstracted to a general form whereby interaction via application code 102 does not require specific understanding of the underlying operating system, but instead relies on abstracted operation requests 104 to make requests of the operating system and the event provider 118 having operating system specific implementations able to query and encapsulate events as they are made available to the application.

In an embodiment, the loop idle time includes time the event loop 114 waits for a response to an event provider request 116 when there is no available response from the event provider 118. Where there is an available response from the event provider 118, the loop idle time does not include the time spent retrieving the response.

In an embodiment, processing capacity of computing resources is scaled up or down in response to the event loop load metric that is determined based at least in part on the period processing time metric. In an embodiment, a user provides threshold values for event loop load for which an auto-scaling event occurs that adjusts computing resources up or down based on the event loop load metric.

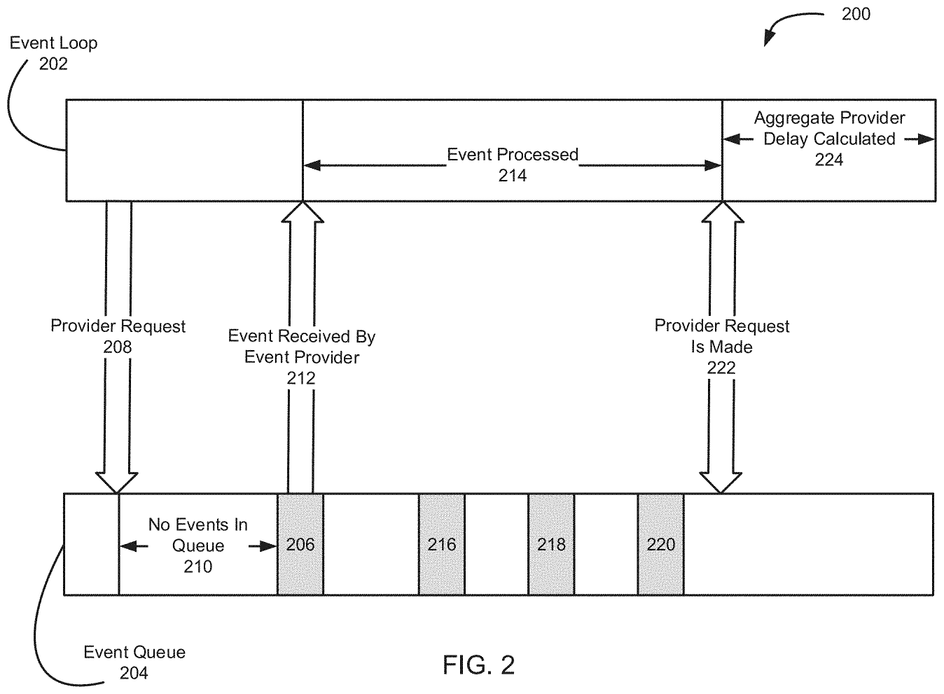

FIG. 2 is a block diagram of a process flow 200 for the processing of events. As shown in the process flow 200, there is communication between the event loop 202 and the event queue 204. Events 206 are illustrated in the process flow 200 as discrete blocks. In the process flow 200, a provider request 208 is made by the event loop 202 to the event queue 204 to query whether any events are waiting in the event queue 204 that need to be retrieved by the event loop. In the example process flow 200 shown in FIG. 2, there are no events in the queue at 210 from the time the provider request is made at 208 to the time the first event 206 is added to the event queue 204. Because there are no events in the queue at 210 when the provider request 208 is made to the event queue, the event loop 202 idles while waiting for an event to be placed in the event queue. An event is placed in the event queue 204 at 212 and is immediately received by the event loop 202 (also at 212) because the event loop 202 was idling when there were no events in the event queue at 210. For this particular loop iteration, because the event loop 202 was idling when there were no events in the queue at 210, the provider delay is equal to zero. The event is processed at 214 immediately after the event is received by the event provider 212 because the event loop 202 was idling. Further for this particular loop iteration, because the event loop 202 was idling prior to receiving the event at 212, the processing delay is also equal to zero.

While the event 206 is being processed at 214, three additional events 216, 218, and 220 are added to the event queue 204. Because the event loop 202 is busy processing the event at 214 when the events 216, 218, 220 are added to the event queue 204, the events 216, 218, 220 must wait in the event queue 204 before being retrieved by the event provider. When the event loop 202 is finished processing the event 206 at 214, a provider request is made at 222 from the event loop 202 to the event queue 204. All three events 216, 218, 220 are retrieved by the event provider at the same time the provider request is made 222. Because the three events 216, 218, 220 were added to the event queue 204 when the event loop 202 was busy processing the event 206 at 214, the time each event 216, 218, 220 was placed in the event queue 204 is unknown. Therefore, the aggregate time all events 216, 218, 220 waited in the event queue (i.e., the provider delay for the events) is approximated at 224.

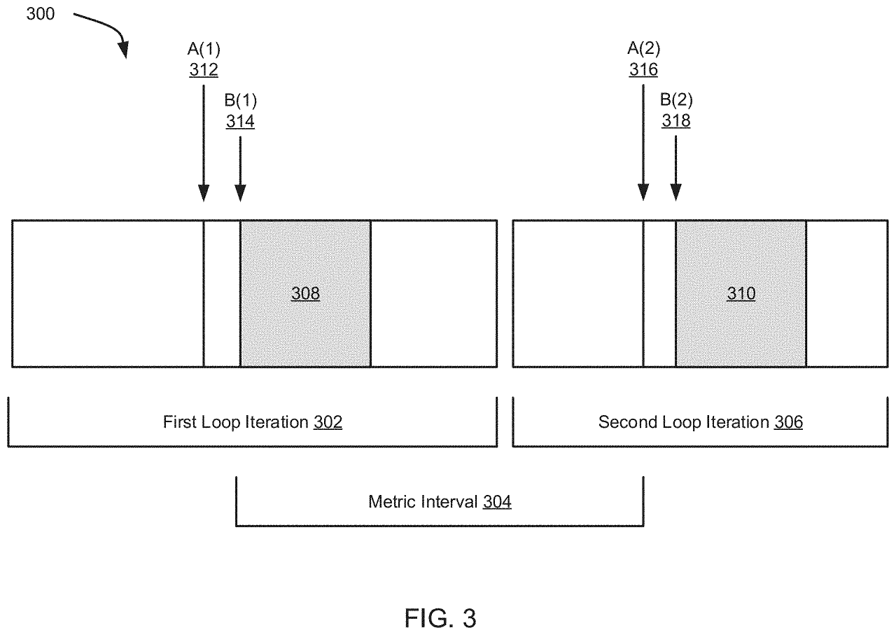

FIG. 3 is a block diagram of an event loop 300. The event loop 300 includes a first loop iteration 302, a second loop iteration 306, and a metric interval 304. Each of the first loop iteration 302 and the second loop iteration 306 is a single iteration of the event loop beginning with an event provider request and ending subsequent to completion of the event provider request. In an embodiment as illustrated in FIG. 3, the metric interval 304 is a duration of time between execution of two subsequent metrics callbacks at B₁ 314 and A₂ 316 as illustrated in FIG. 3. In FIG. 3, points A₁ 312 and A₂ 316 indicate timestamps where metrics callbacks are called. Points B₁ 314 and B₂ 318 indicate where the event provider 118 is entered as a result of an event provider request 116, (alternatively referred to as the entering of the poll phase), namely the first event provider 308 and the second event provider 310, respectively. The metric interval 304 roughly corresponds to a duration of time it takes for an iteration (or “turn”) of the event loop 114 (which also includes execution of application code 102), for example the duration of time for the first loop iteration 302 and/or the second loop iteration 306. The metric interval 304 may be generated by recording and comparing timestamps between calls of the metrics callback.

A metrics callback is a call by an instrumented event loop into the metrics calculation subsystem. Such a callback is triggered by the event loop at a predetermined point in the event loop such that accuracy is maximized and impact on event loop performance is minimized.

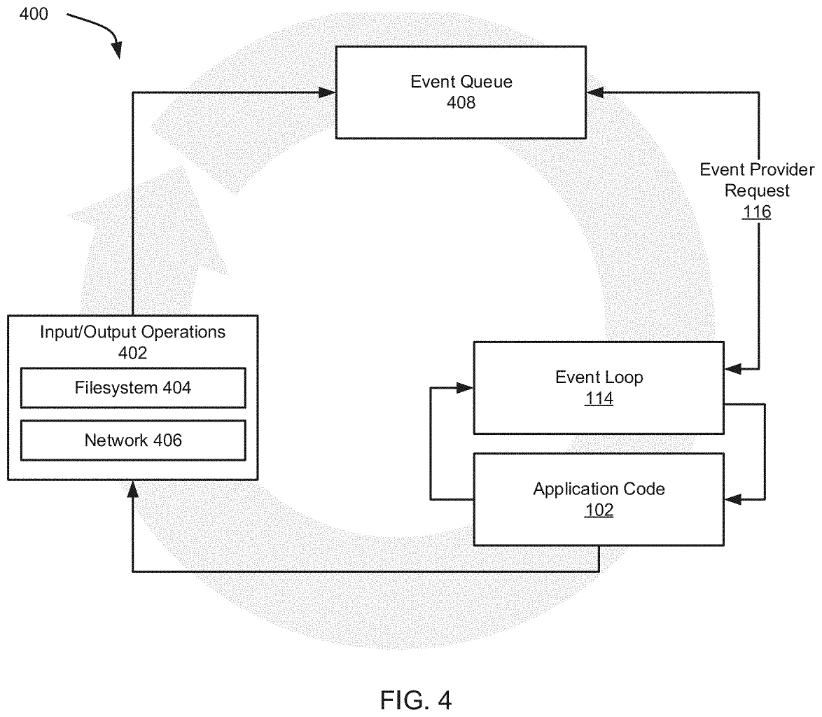

FIG. 4 is a schematic block diagram of an iteration 400 of an event loop. The iteration 400 begins within the application code 102. During synchronous execution, the application code 102 initiates a request to a subsystem 402 for performing input/output operations that is configured to perform operations asynchronously. The subsystem 402 may include a filesystem 404 and a network 406 connection. When the requested operation is completed by the subsystem 402, an event is placed in the event queue 408. When synchronous execution of the application code 102 is complete, the event loop 114 performs the event provider request 116. The event provider (within the event loop 114) continues to block execution until an event is received or a timeout expires. When the event provider receives an event, the event is passed to the event handler to be processed by the application code 102.

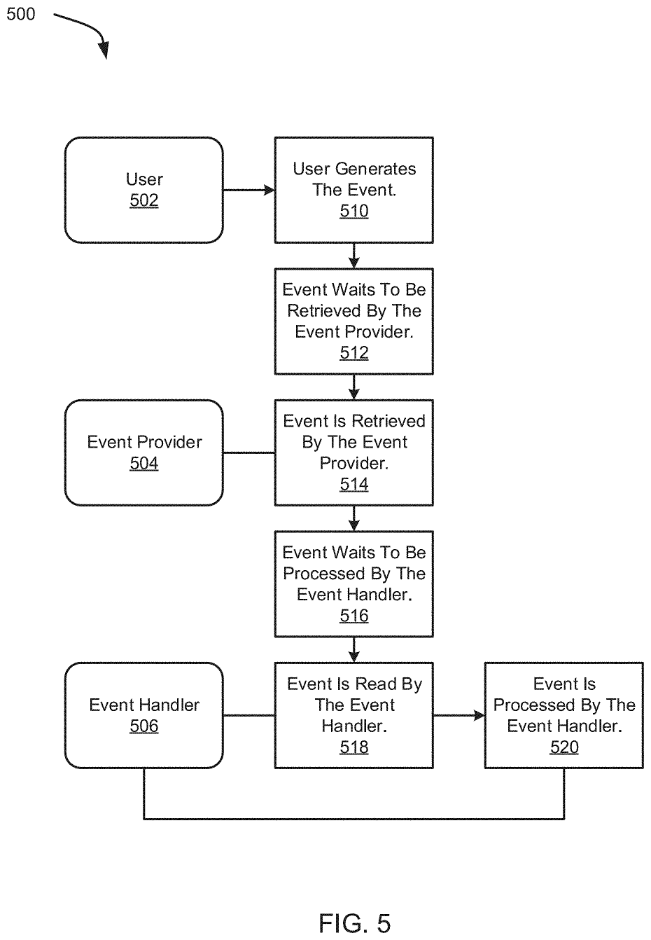

FIG. 5 is a schematic block diagram illustrating a process flow 500 for an event within an event loop (see 114). The process flow 500 is implemented by a user 502, an event provider 504, and an event handler 506. The user may include a person or programming logic that interacts with a program to generate an event. In the process flow 500, the user 502 generates the event at 510. The event polls within the event loop and waits at 512 to be retrieved by the event provider 504. The event is retrieved at 514 by the event provider 504. The event waits at 516 to be processed by the event handler 506. The event is read at 518 by the event handler 506. The event is processed at 520 by the event handler 506.

To aid in understanding the process flow 500, the process flow 500 may be analogized to tasks being received in an inbox and then performed (the same analogy recited above). According to the analogy, the user 502 can be analogized to a person or entity that delivers a task to the inbox. The event provider 504 can be analogized to a secretary that receives the tasks at the inbox and then provides the tasks to a worker. The event handler 506 can be analogized to the worker that receives the tasks from the secretary and then performs the tasks.

In an analogy of the process flow 500, multiple tasks are delivered to the inbox, and the tasks may be delivered at the same time or at different times (see 510). The multiple tasks wait in the inbox (see 512). The multiple tasks are retrieved by the secretary (see 514). The multiple tasks wait before being opened and performed by the worker (see 516). Each of the multiple tasks are opened and performed by a different worker (see 518). Each of the different workers do some action to perform the task (see 520).

Further to this analogy, the different workers configured to perform the tasks signify that multiple event handlers 506 may be in communication with a single event loop, and the multiple event handlers 506 may process events in parallel. Further as illustrated in the analogy, events may be generated at different times and a collection of events may wait to be retrieved by the event provider 504. During an iteration of the event loop, the event provider 504 may retrieve each of the events that has been waiting and may simultaneously provide each of the events to the event handler 506.

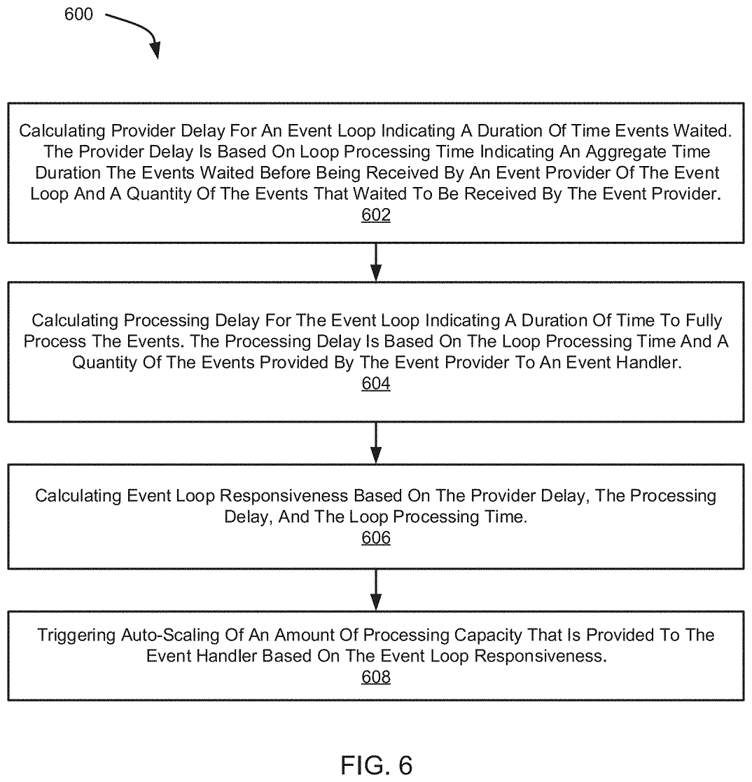

FIG. 6 illustrates a schematic flow chart diagram of a method 600 for determining event loop responsiveness of a server. The method 600 may be performed by any suitable computing device. Such computing device may be in communication with an event loop 114 and/or may receive metrics determined based on activity of the event loop 114.

The method 600 begins and the computing device calculates at 602 provider delay for an event loop indicating a duration of time events waited. The provider delay is based on loop processing time indicating an aggregate time duration the events waited before being received by an event provider of the event loop. The provider delay is further based on a quantity of the events that waited to be received by the event provider. The method 600 continues and a computing device calculates at 604 processing delay for the event loop indicating a duration of time to fully process the events. The processing delay is based on the loop processing time. The processing delay is further based on a quantity of the events provided by the event provider to an event handler of the event loop. The method 600 continues and a computing device calculates at 606 event loop responsiveness based on the provider delay, the processing delay, and the loop processing time. The method 600 continues and a computing device triggers at 608 auto-scaling of an amount of processing capacity that is provided to the event handler based on the event loop responsiveness.

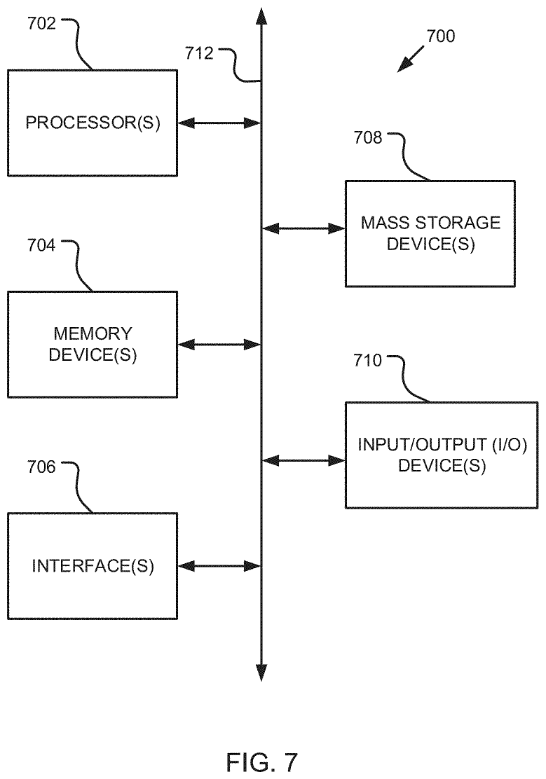

FIG. 7 is a block diagram depicting an example computing device 700. In some embodiments, computing device 700 is used to implement one or more of the systems and components discussed herein. Further, computing device 700 may interact with any of the systems and components described herein. Accordingly, computing device 700 may be used to perform various procedures and tasks, such as those discussed herein, including for example determining a processing time for an event loop. Computing device 700 can function as a server, a client or any other computing entity. Computing device 700 can be any of a wide variety of computing devices, such as a desktop computer, a notebook computer, a server computer, a handheld computer, a tablet, and the like.

Computing device 700 includes one or more processor(s) 702, one or more memory device(s) 704, one or more interface(s) 706, one or more mass storage device(s) 708, and one or more Input/Output (I/O) device(s) 710, all of which are coupled to a bus 712. Processor(s) 702 include one or more processors or controllers that execute instructions stored in memory device(s) 704 and/or mass storage device(s) 708. Processor(s) 702 may also include various types of computer-readable media, such as cache memory.

Memory device(s) 704 include various computer-readable media, such as volatile memory (e.g., random access memory (RAM)) and/or nonvolatile memory (e.g., read-only memory (ROM)). Memory device(s) 704 may also include rewritable ROM, such as Flash memory.

Mass storage device(s) 708 include various computer readable media, such as magnetic tapes, magnetic disks, optical disks, solid state memory (e.g., Flash memory), and so forth. Various drives may also be included in mass storage device(s) 708 to enable reading from and/or writing to the various computer readable media. Mass storage device(s) 708 include removable media and/or non-removable media.

I/O device(s) 710 include various devices that allow data and/or other information to be input to or retrieved from computing device 700. Example I/O device(s) 710 include cursor control devices, keyboards, keypads, microphones, monitors or other display devices, speakers, printers, network interface cards, modems, lenses, CCDs or other image capture devices, and the like.

Interface(s) 706 include various interfaces that allow computing device 700 to interact with other systems, devices, or computing environments. Example interface(s) 706 include any number of different network interfaces, such as interfaces to local area networks (LANs), wide area networks (WANs), wireless networks, and the Internet.

Bus 712 allows processor(s) 702, memory device(s) 704, interface(s) 706, mass storage device(s) 708, and I/O device(s) 710 to communicate with one another, as well as other devices or components coupled to bus 712. Bus 712 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 700 and are executed by processor(s) 702. Alternatively, the systems and procedures described herein can be implemented in hardware, or a combination of hardware, software, and/or firmware. For example, one or more application specific integrated circuits (ASICs) can be programmed to carry out one or more of the systems and procedures described herein. As used herein, the terms “module” or “component” are intended to convey the implementation apparatus for accomplishing a process, such as by hardware, or a combination of hardware, software, and/or firmware, for the purposes of performing all or parts of operations disclosed herein.

### EXAMPLE IMPLEMENTATIONS

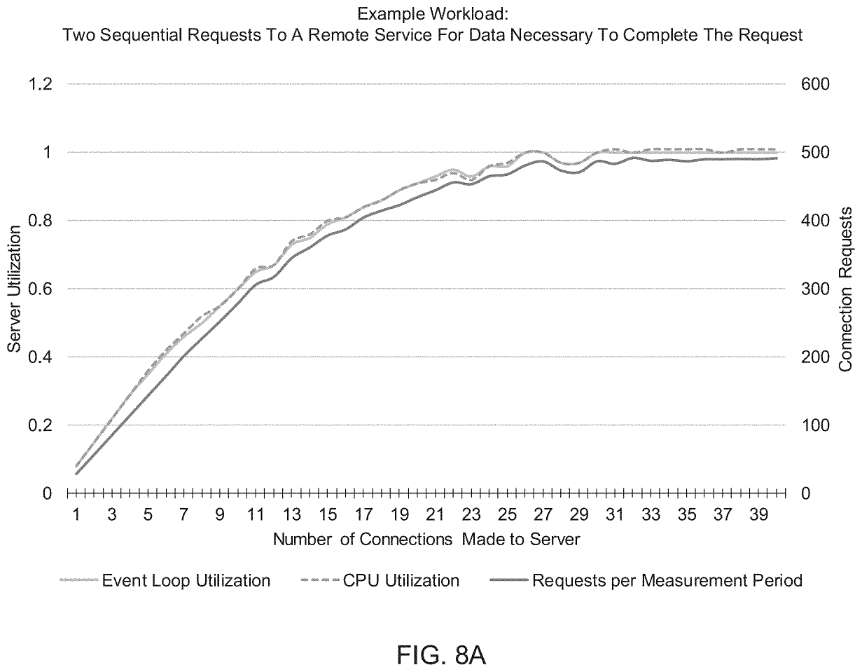

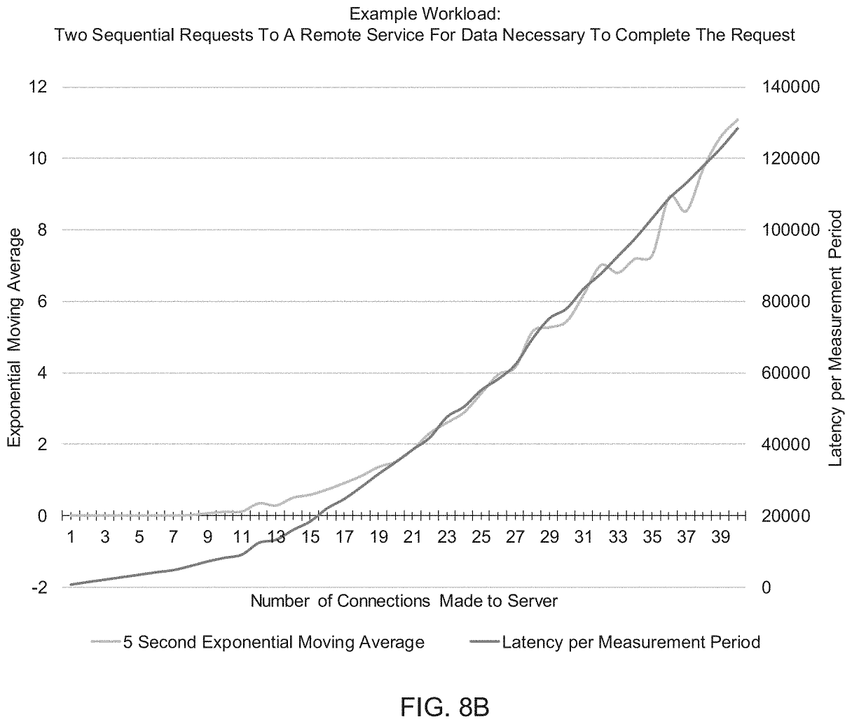

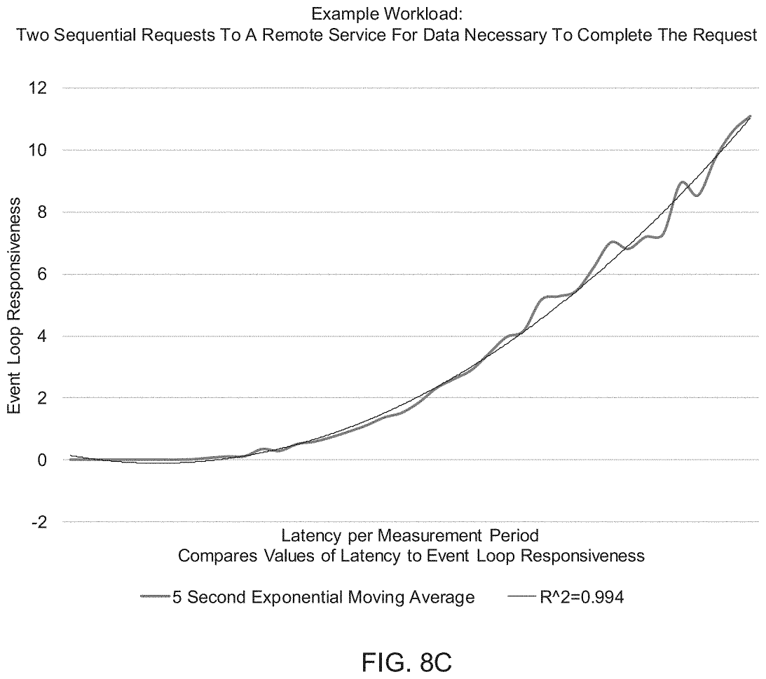

FIGS. 8A-11C depict the unexpectedly good results achieved by calculating event loop responsiveness according to the methods, systems, and devices disclosed herein. The graphs shown in FIGS. 8A-11C demonstrate the correlation between the event loop responsiveness metric as calculating according to the disclosures herein, and the responsiveness metric as measured directly from an application. The graphs illustrate real example data acquired by applying the calculations disclosed herein and comparing those calculations against metrics measured directly from an application. The example implementations depicted in the graphs are based on HTTP servers simulating a variety of production scenarios. The correlation shown in the graphs between the event loop responsiveness (as calculated according to the disclosure) and actual HTTP server metrics show that the event loop responsiveness does not need to be determined based on any actual HTTP server metrics. Instead, the event loop responsiveness can be determined by estimating operations of the HTTP server and analyzing metrics taken from event loop operations. This ensures that operation metrics do not need to be performed by the HTTP server itself, and therefore the processing capacity of the HTTP server does not need to be consumed by metric calculation and responsiveness analysis. The event loop responsiveness can instead be calculated based on observations of the event loop without using metrics determined by the HTTP server. This presents numerous benefits and particularly frees up processing capacity on the HTTP server for performing applications tasks. The comparisons shown in the graphs demonstrate unexpectedly good results and show that the calculations described herein closely match HTTP server metrics.

FIGS. 8A-8C depict an example workload that makes two sequential requests to a remote service for data necessary to complete the request. Each remote request responds within 10 milliseconds. After the remote requests are completed, approximately 10 milliseconds are required to prepare the response.

FIG. 8A shows growth of how many requests can be made as the amount of traffic increases. The x-axis depicts an increase in the number of connections made to the server. The y-axis depicts an increase in the number of connection requests. Each connection makes the same type of request at a set interval. As shown in FIG. 8, there is only linear growth of requests to connections at the very beginning, and then the growth gradually tapers off until the maximum number of requests is reached.

The amount of CPU utilization and event loop utilization are shown for comparison of resource usage to requests completed. Each data point is an average of medians taken from multiple runs of the benchmark.

FIG. 8B is a graph comparing latency with the event loop responsiveness. The latency per period line shows the amount of time it took to respond to each request as the number of requests increased. The event loop responsiveness metric as shown in FIG. 8B is taken from the exponential moving average using a five second weight.

FIG. 8C is a graph comparing the actual latency of the HTTP server and the event loop responsiveness metric as calculated according to the disclosure. FIG. 8C plots the values of the event loop responsiveness using the latency values shown in FIG. 8B. The trendline of the event loop responsiveness is a second-degree polynomial. As shown in FIG. 8C, there is extremely high correlation between the event loop responsiveness metric as calculated according to the disclosures, and the actual latency of the HTTP server.

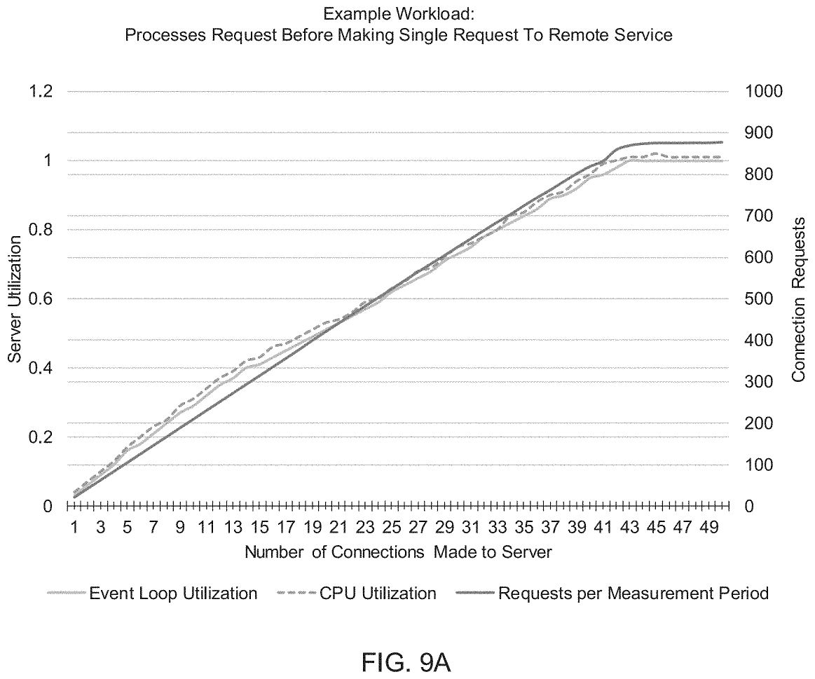

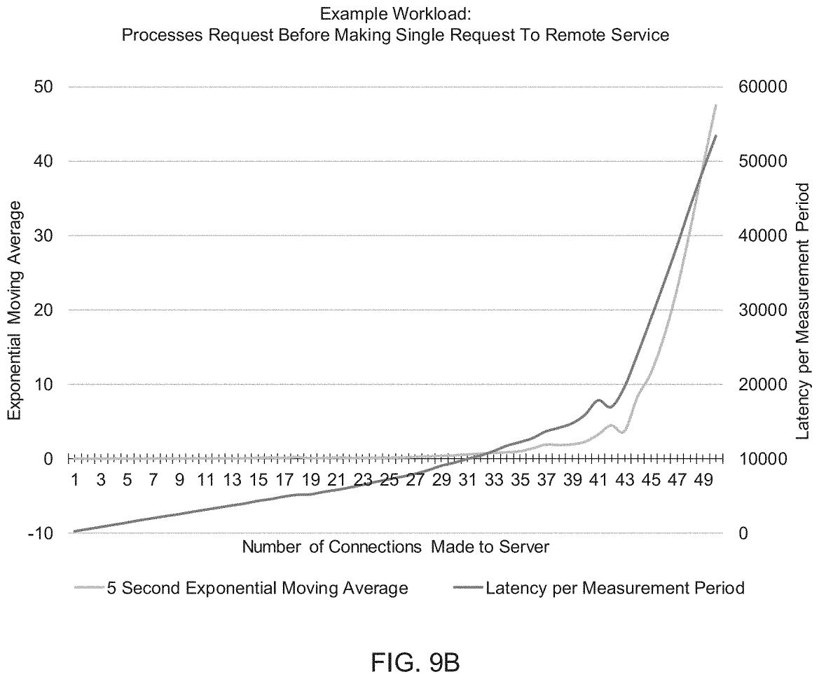

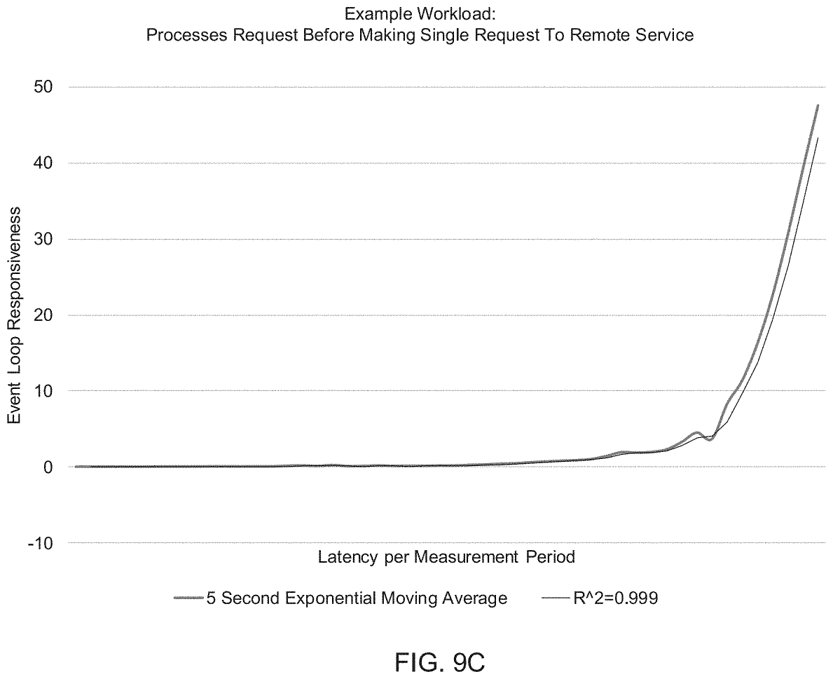

FIGS. 9A-9C depict an example workload that spends time processing a user's request before making a single request to a remote service that can respond quickly. The data received from the remote service is used to generate a response to the user's request, and this takes approximately five milliseconds. FIGS. 9A-9C demonstrate that the event loop responsiveness metric as disclosed herein shows extremely high correlation with actual measured latency event when there are significant differences in the amount of processing. When a request requires off-thread work, as in the examples shown in FIGS. 9A-9C, there is a request for other processing resources to do some work and then notify the event loop when the work is complete. This scenario can skew metrics because it places special constraints on the server.

FIG. 9A shows the growth of how many requests can be made as the amount of traffic increases. The x-axis depicts an increase in the number of connections that are made to the server. Each connection makes the same type of request at a set interval. As shown in FIG. 9A, the number of responses is nearly linear while traffic increases until maximum capacity is reached. The CPU utilization and event loop utilization metrics are included for comparison of resource usage requests completed. Each data point is an average median taken from multiple runs of the benchmark.

FIG. 9B is a graph depicting the amount of time it took to respond to each request as the number of requests increased. FIG. 9B depicts the latency per period and the event loop responsiveness metric as calculated according to the disclosures herein. The event loop responsiveness metric as shown in FIG. 9B is calculated based on measurements taken from the exponential moving average using a five second weight.

FIG. 9C is a graph that plots values of the event loop responsiveness using latency values from the graph depicted in FIG. 9B. The trendline is a second-degree polynomial. As shown in FIG. 9C, there is extremely high correlation between the event loop responsiveness (as calculated according to the disclosures herein) and the actual latency of the HTTP server.

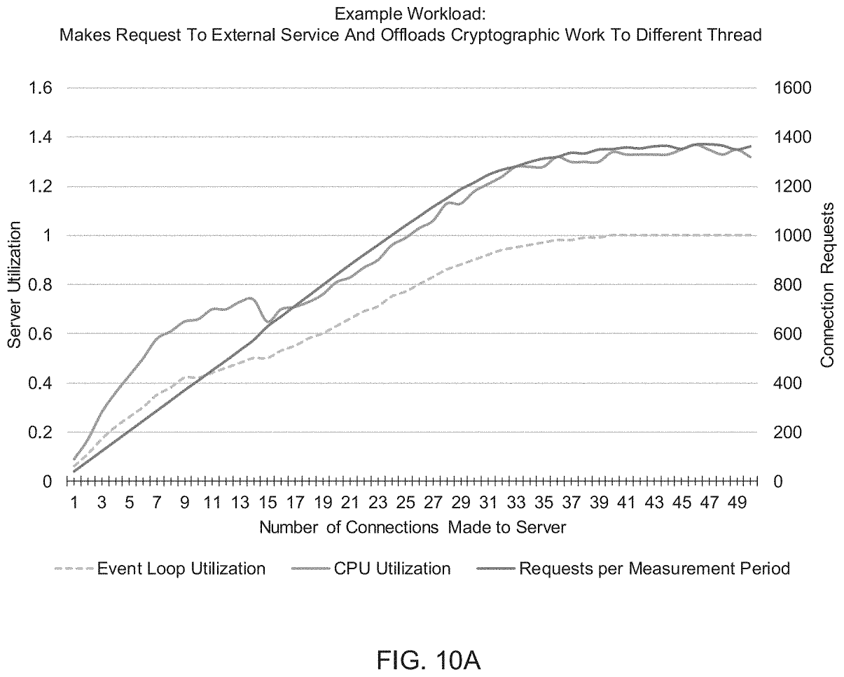

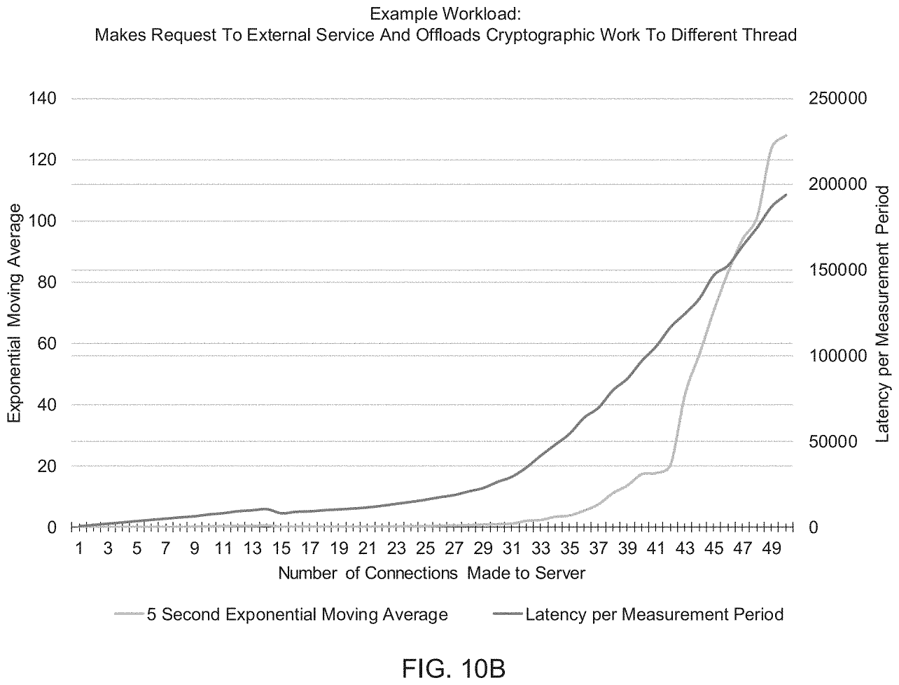

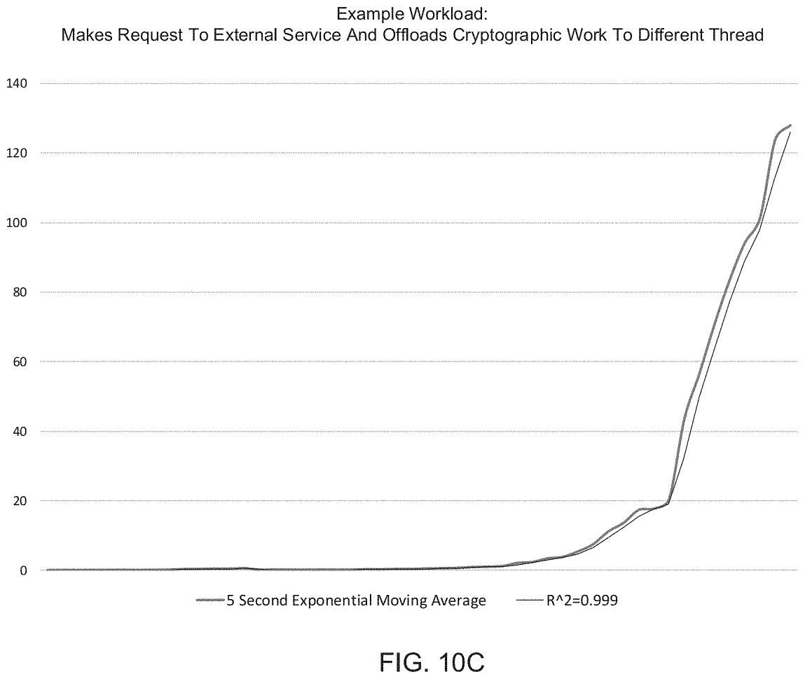

FIGS. 10A-10C depict an example workload that first makes a request to an external service. After the response, the system offloads cryptographic work to a different thread. The result of this is illustrated in the graph because the CPU utilization is greater than the event loop utilization. The system uses the result for the cryptographic work to generate a result to the user's request. The requests made to the different thread are pipelined such that a batch of requests is generated at once. FIGS. 10A-10C demonstrate that the event loop responsiveness metric as disclosed herein has extremely high correlation with actual measured latency values event when there are multiple requests made per event. In most scenarios, there is a nearly 1:1 correlation between events and requests. Mathematically, this 1:1 correlation simplifies the calculations because an assumption can be made that the number of events is equal to the number of requests. FIGS. 10A-10C demonstrate that the event loop responsiveness metric as described herein shows extremely high correlation even when this assumption of a 1:1 correlation between events and requests cannot be made. FIGS. 10A-10C therefore show that the event loop responsiveness metric shows unexpectedly good results for predicting responsiveness of a server even when the implementation is atypical and certain mathematical assumptions cannot be made.

FIG. 10A is a graph showing the growth of how many requests can be made as the amount of traffic increases. The x-axis is an increase in the number of connections that are made to the server. Each connection makes the same type of request at a set interval. As shown in FIG. 10A, there is only linear growth of requests to connections at the beginning and then the growth in the number of requests begins to taper off until the maximum number of requests is reached. The CPU utilization and the event loop utilization are included in FIG. 10A for comparison of resource usage to requests completed. Each data point is an average of medians taken from multiple runs of the benchmark.

FIG. 10B is a graph showing the amount of time it took to respond to each request as the number of requests increased. FIG. 10B depicts the latency per period compared with the event loop responsiveness metric (as calculated according to the disclosures herein). The event loop responsiveness metric is taken from the exponential moving average using a five second weight.

FIG. 10C is a graph that plots the values of the event loop responsiveness metric using the latency values used in FIG. 10B. The trendline is a second-degree polynomial. As shown in FIG. 10C, there is very high correlation between the event loop responsiveness metric (as calculated according to the disclosures herein) and the actual latency of the HTTP server.

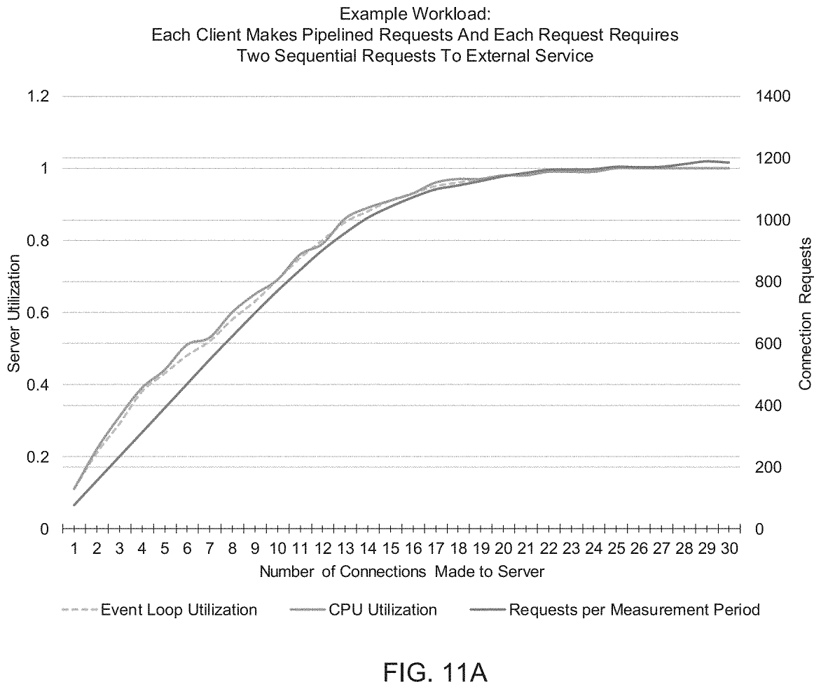

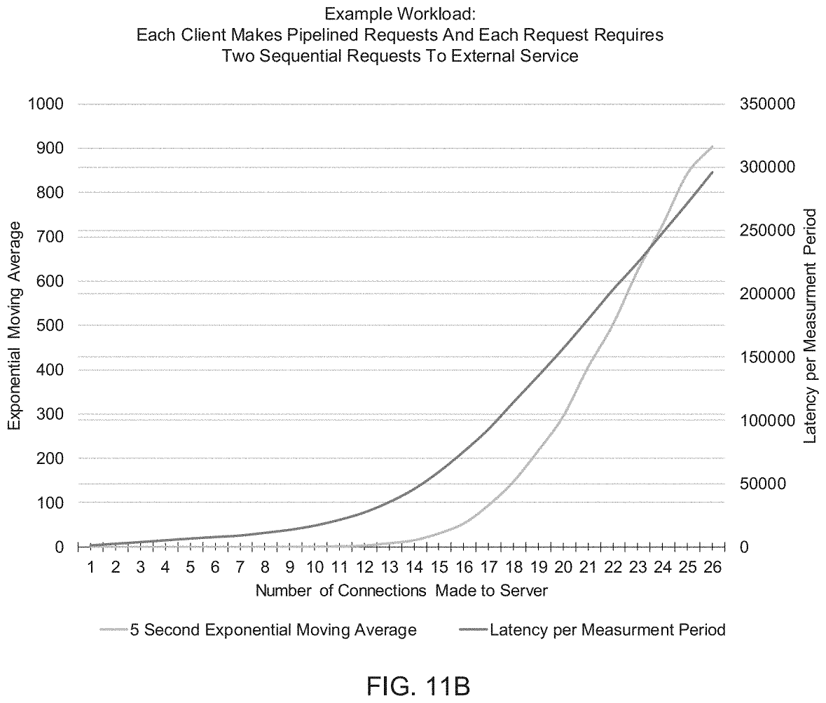

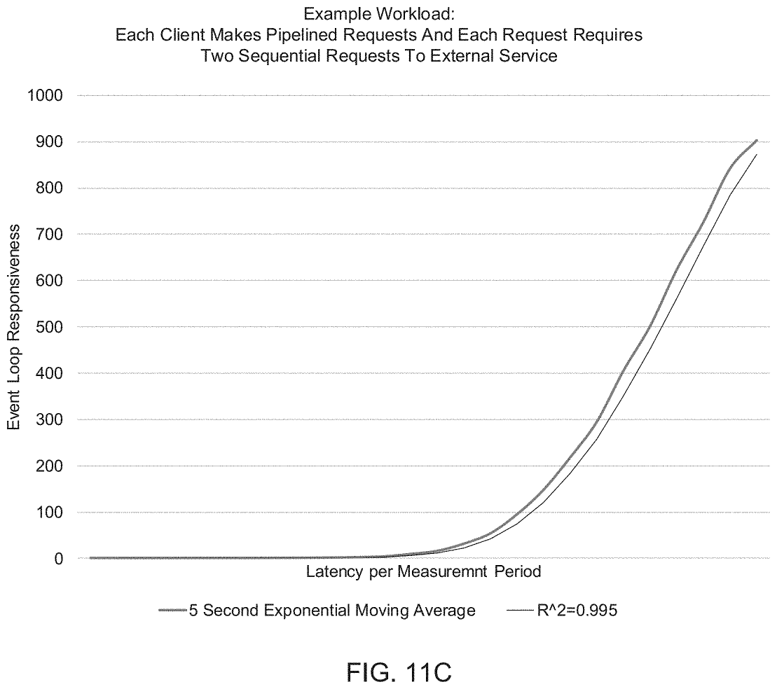

FIGS. 11A-11C depict an example workload that has each client making several pipelined requests. Each request requires two sequential requests to an external service. After the request is made to the external service, a small amount of processing is performed on the data received from the external service before responding to the client.

FIG. 11A is a graph showing the growth of how many requests can be made as the amount of traffic increases. The x-axis is an increase in the number of connections that are made to the server. Each connection makes the same type of request at a set interval. As shown in FIG. 10C, the number of responses remains nearly linear while traffic increases, until maximum capacity is reached. The CPU utilization and event loop utilization are included in FIG. 11A for comparison of resource usage to request completed. Each data point is an average of medians taken from multiple runs of the benchmark.

FIG. 11B is a graph depicting the amount of time it took to respond to each request as the number of requests increased. FIG. 11B compares the latency per period with the event loop responsiveness metric (as calculated according to the disclosures herein). The event loop responsiveness metric shown in FIG. 11B is calculated based on the exponential moving average using a five second weight.

FIG. 11C is a graph that plots values of the event loop responsiveness metric (as calculated according to the disclosures provided herein) using the latency values from FIG. 11B. The trendline is a second-degree polynomial. As shown in FIG. 11C, there is very high correlation between the event loop responsiveness metric and the actual latency of the HTTP server.

### EXAMPLE EMBODIMENTS

The following examples pertain to further embodiments.

Example 1 is a system. for measuring event loop responsiveness of a server. The system includes means for calculating provider delay for an event loop indicating a duration of time events waited based on loop processing time indicating an aggregate time duration the events waited before being received by an event provider of the event loop and a quantity of the events that waited to be received by the event provider. The system includes means for calculating processing delay for the event loop indicating a duration of time to fully process the events based on the loop processing time and a quantity of the events provided by the event provider to an event handler.

Example 2 is a system as in Example 1, further comprising means for calculating the event loop responsiveness based on the provider delay, the processing delay, and the loop processing time.

Example 3 is a system as in any of Examples 1-2, further comprising means for triggering auto-scaling of an amount of processing capacity that is provided to the event handler based on the event loop responsiveness.

Example 4 is a system as in any of Examples 1-3, further comprising means for scaling processing capacity that is provided to the event handler based on the event loop responsiveness to minimize processing usage of the server or to minimize latency on the server in accordance with user-specified threshold parameters.

Example 5 is a system as in any of Examples 1-4, further comprising: means for identifying whether the event loop responsiveness complies with a user-specified acceptable range for the event loop responsiveness; and means for generating a notification indicating whether the server complies with the user-specified acceptable range for the event loop responsiveness.

Example 6 is a system as in any of Examples 1-5, further comprising: means for calculating the loop processing time by summing all individual time durations each of the events waited after being received by the event provider and before beginning to be processed by the event handler for one iteration of the event loop; means for calculating the quantity of the events that waited to be received by the event provider by summing the events that waited to be received by the event provider for the one iteration of the event loop; and means for calculating the quantity of the events provided by the event provider to the event handler by summering the events provided by the event provider to the event handler for the one iteration of the event loop.

Example 7 is a system as in any of Examples 1-6, further comprising: means for calculating an average provider delay over multiple iterations of the event loop; means for calculating an average processing delay over multiple iterations of the event loop; and means for calculating an average event loop responsiveness based on the average provider delay and the average processing delay.

Example 8 is a system as in any of Examples 1-7, further comprising means for triggering auto-scaling of an amount of processing resources provided to the event handler based on the event loop responsiveness and not based on actual server metrics.

Example 9 is a system as in any of Examples 1-8, further comprising means for determining a maximum workload for the server wherein the maximum workload consumes all available processing resources on the server.

Example 10 is a system as in any of Examples 1-9, wherein: the means for calculating the provider delay comprises means for calculating the provider delay indirectly such that overhead is not added to a program associated with the event loop; and the means for calculating the processing delay comprises means for calculating the processing delay indirectly such that overhead is not added to the program associated with the event loop.

Example 11 is a method for measuring event loop responsiveness of a server. The method includes calculating provider delay for an event loop indicating a duration of time events waited, the provider delay based on loop processing time indicating an aggregate time duration the events waited before being received by an event provider of the event loop and a quantity of the events that waited to be received by the event provider. The method includes calculating processing delay for the event loop indicating a duration of time to fully process the events, the processing delay based on the loop processing time and a quantity of the events provided by the event provider to an event handler.

Example 12 is a method as in Example 11, further comprising calculating the event loop responsiveness based on the provider delay, the processing delay, and the loop processing time.

Example 13 is a method as in any of Examples 11-12, further comprising triggering auto-scaling of an amount of processing capacity that is provided to the event handler based on the event loop responsiveness.

Example 14 is a method as in any of Examples 11-13, further comprising scaling processing capacity that is provided to the event handler based on the event loop responsiveness to minimize processing usage of the server or to minimize latency on the server in accordance with user-specified threshold parameters.

Example 15 is a method as in any of Examples 11-14, further comprising: identifying whether the event loop responsiveness complies with a user-specified acceptable range for the event loop responsiveness and generating a notification indicating whether the server complies with the user-specified acceptable range for the event loop responsiveness.

Example 16 is a method as in any of Examples 11-15, further comprising: calculating the loop processing time by summing all individual time durations each of the events waited after being received by the event provider and before beginning to be processed by the event handler for one iteration of the event loop; calculating the quantity of the events that waited to be received by the event provider by summing the events that waited to be received by the event provider for the one iteration of the event loop; and calculating the quantity of the events provided by the event provider to the event handler by summering the events provided by the event provider to the event handler for the one iteration of the event loop.

Example 17 is a method as in any of Examples 11-16, further comprising: calculating an average provider delay over multiple iterations of the event loop; calculating an average processing delay over multiple iterations of the event loop; and calculating an average event loop responsiveness based on the average provider delay and the average processing delay.

Example 18 is a method as in any of Examples 11-17, further comprising triggering auto-scaling of an amount of processing resources provided to the event handler based on the event loop responsiveness and not based on actual server metrics.

Example 19 is a method as in any of Examples 11-18, further comprising determining a maximum workload for the server wherein the maximum workload consumes all available processing resources on the server.

Example 20 is a method as in any of Examples 11-19, wherein calculating the provider delay comprises calculating indirectly such that overhead is not added to a program associated with the event loop and calculating the processing delay comprises calculating indirectly such that overhead is not added to the program associated with the event loop.

Example 21 is a processor that is programmable to execute instructions stored in non-transitory computer readable storage media. The instructions include calculating provider delay for an event loop indicating a duration of time events waited, the provider delay based on loop processing time indicating an aggregate time duration the events waited before being received by an event provider of the event loop and a quantity of the events that waited to be received by the event provider. The instructions include calculating processing delay for the event loop indicating a duration of time to fully process the events, the processing delay based on the loop processing time and a quantity of the events provided by the event provider to an event handler.

Example 22 is a processor as in Example 21, wherein the instructions further comprise calculating the event loop responsiveness based on the provider delay, the processing delay, and the loop processing time and one or more of: triggering auto-scaling of an amount of processing capacity that is provided to the event handler based on the event loop responsiveness; scaling processing capacity that is provided to the event handler based on the event loop responsiveness to minimize processing usage of the server or to minimize latency on the server in accordance with user-specified threshold parameters; identifying whether the event loop responsiveness complies with a user-specified acceptable range for the event loop responsiveness; or generating a notification indicating whether the server complies with the user-specified acceptable range for the event loop responsiveness.

Example 23 is a processor as in any of Examples 21-22, wherein the instructions further comprise: calculating the loop processing time by summing all individual time durations each of the events waited after being received by the event provider and before beginning to be processed by the event handler for one iteration of the event loop; calculating the quantity of the events that waited to be received by the event provider by summing the events that waited to be received by the event provider for the one iteration of the event loop; and calculating the quantity of the events provided by the event provider to the event handler by summering the events provided by the event provider to the event handler for the one iteration of the event loop.

Example 24 is a processor as in any of Examples 21-23, wherein the instructions further comprise: calculating an average provider delay over multiple iterations of the event loop; calculating an average processing delay over multiple iterations of the event loop; and calculating an average event loop responsiveness based on the average provider delay and the average processing delay.

Example 25 is a processor as in any of Examples 21-24, wherein the instructions further comprise triggering auto-scaling of an amount of processing resources provided to the event handler based on the event loop responsiveness and not based on actual server metrics.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

Many of the functional units described in this specification may be implemented as one or more components, which is a term used to more particularly emphasize their implementation independence. For example, a component may be implemented as a hardware circuit comprising custom very large-scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processes. An identified component of executable code may, for instance, comprise one or more physical or logical blocks of computer instructions, which may, for instance, be organized as an object, a procedure, or a function. Nevertheless, the executables of an identified component need not be physically located together but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components and may be embodied in any suitable form and organized within any suitable type of data structure. The operational data may be collected as a single data set or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the following claims.

What is claimed is:

1. A system for measuring event loop responsiveness of a server, the system comprising:
means for calculating provider delay for an event loop indicating a duration of time events waited, the provider delay based on:
a loop processing time indicating an aggregate time duration the events waited before being received by an event provider of the event loop; and
a quantity of the events that waited to be received by the event provider; and
means for calculating processing delay for the event loop indicating a duration of time to fully process the events, the processing delay based on:
the loop processing time; and
a quantity of the events provided by the event provider to an event handler.

2. The system of claim 1, further comprising means for calculating the event loop responsiveness based on the provider delay, the processing delay, and the loop processing time.

3. The system of claim 2, further comprising means for triggering auto-scaling of an amount of processing capacity that is provided to the event handler based on the event loop responsiveness.

4. The system of claim 2, further comprising means for scaling processing capacity that is provided to the event handler based on the event loop responsiveness to minimize processing usage of the server or to minimize latency on the server in accordance with user-specified threshold parameters.

5. The system of claim 2, further comprising:
means for identifying whether the event loop responsiveness complies with a user-specified acceptable range for the event loop responsiveness; and
means for generating a notification indicating whether the server complies with the user-specified acceptable range for the event loop responsiveness.

6. The system of claim 1, further comprising:
means for calculating the loop processing time by summing all individual time durations each of the events waited after being received by the event provider and before being dispatched to the event handler for one loop iteration of the event loop; and
means for calculating the quantity of the events that are dispatched to the event handler by summing all events provided by the event provider to the event handler for one loop iteration of the event loop.

7. The system of claim 6, further comprising:
means for calculating an average provider delay over multiple iterations of the event loop;
means for calculating an average processing delay over multiple iterations of the event loop; and
means for calculating an average event loop responsiveness based on the average provider delay and the average processing delay.

8. The system of claim 7, further comprising means for triggering auto-scaling of an amount of processing resources provided to the event handler based on the event loop responsiveness and not based on application specific metrics.

9. The system of claim 1, wherein:
the means for calculating the provider delay comprises means for calculating the provider delay indirectly such that overhead is not added to a program associated with the event loop; and
the means for calculating the processing delay comprises means for calculating the processing delay indirectly such that overhead is not added to the program associated with the event loop.

10. A method for measuring event loop responsiveness of a server, the method comprising:
calculating provider delay for an event loop indicating a duration of time events waited, the provider delay based on:
a loop processing time indicating an aggregate time duration the events waited before being received by an event provider of the event loop; and
a quantity of the events that waited to be received by the event provider; and
calculating processing delay for the event loop indicating a duration of time to fully process the events, the processing delay based on:
the loop processing time; and
a quantity of the events provided by the event provider to an event handler.

11. The method of claim 10, further comprising calculating the event loop responsiveness based on the provider delay, the processing delay, and the loop processing time.

12. The method of claim 11, further comprising triggering auto-scaling of an amount of processing capacity that is provided to the event handler based on the event loop responsiveness.

13. The method of claim 11, further comprising scaling processing capacity that is provided to the event handler based on the event loop responsiveness to minimize processing usage of the server or to minimize latency on the server in accordance with user-specified threshold parameters.

14. The method of claim 11, further comprising:
identifying whether the event loop responsiveness complies with a user-specified acceptable range for the event loop responsiveness; and
generating a notification indicating whether the server complies with the user-specified acceptable range for the event loop responsiveness.

15. The method of claim 10, further comprising:
calculating the loop processing time by summing all individual time durations each of the events waited after being received by the event provider and before being dispatched to the event handler for one loop iteration of the event loop; and
calculating the quantity of the events that are dispatched to the event handler by summing all events provided by the event provider to the event handler for one loop iteration of the event loop.

16. The method of claim 15, further comprising:
calculating an average provider delay over multiple iterations of the event loop;
calculating an average processing delay over multiple iterations of the event loop; and
calculating an average event loop responsiveness based on the average provider delay and the average processing delay.

17. The method of claim 16, further comprising triggering auto-scaling of an amount of processing resources provided to the event handler based on the event loop responsiveness and not based on application specific metrics.

18. The method of claim 10, wherein:
calculating the provider delay comprises calculating indirectly such that overhead is not added to a program associated with the event loop; and
calculating the processing delay comprises calculating indirectly such that overhead is not added to the program associated with the event loop.

19. A processor that is programmable to execute instructions stored in non-transitory computer readable storage media, the instructions comprising:
calculating provider delay for an event loop indicating a duration of time events waited, the provider delay based on:
loop processing time indicating an aggregate time duration the events waited before being received by an event provider of the event loop; and
a quantity of the events that waited to be received by the event provider; and
calculating processing delay for the event loop indicating a duration of time to fully process the events, the processing delay based on:
the loop processing time; and
a quantity of the events provided by the event provider to an event handler.

20. The processor of claim 19, wherein the instructions further comprise calculating the event loop responsiveness based on the provider delay, the processing delay, and the loop processing time and one or more of:
triggering auto-scaling of an amount of processing capacity that is provided to the event handler based on the event loop responsiveness;
scaling processing capacity that is provided to the event handler based on the event loop responsiveness to minimize processing usage of the server or to minimize latency on the server in accordance with user-specified threshold parameters;
identifying whether the event loop responsiveness complies with a user-specified acceptable range for the event loop responsiveness; or
generating a notification indicating whether the server complies with the user-specified acceptable range for the event loop responsiveness

21. The processor of claim 19, wherein the instructions further comprise:
calculating the loop processing time by summing all individual time durations each of the events waited after being received by the event provider and before being dispatched to the event handler for one loop iteration of the event loop; and
calculating the quantity of the events that are dispatched to the event handler by summing all events provided by the event provider to the event handler for one loop iteration of the event loop.

22. The processor of claim 21, wherein the instructions further comprise:
calculating an average provider delay over multiple iterations of the event loop;
calculating an average processing delay over multiple iterations of the event loop; and
calculating an average event loop responsiveness based on the average provider delay and the average processing delay.

23. The processor of claim 22, wherein the instructions further comprise triggering auto-scaling of an amount of processing resources provided to the event handler based on the event loop responsiveness and not based on actual server metrics.
